(19) United States
(12) Patent Application Publication
(10) Pub. No.: US 2023/0230354 A1
(43) Pub. Date: Jul. 20, 2023

(54) INTENTION DETECTION DEVICE, INTENTION DETECTION METHOD COMPUTER-READABLE STORAGE MEDIUM

(71) Applicant: NEC Corporation, Minato-ku, Tokyo (JP)

(72) Inventor: Alexander VIEHWEIDER, Tokyio (JP)

(73) Assignee: NEC Corporation, Minato-ku, Tokyo (JP)

(21) Appl. No.: 18/009,202

(22) PCT Filed: Jun. 12, 2020
(86) PCT No.: PCT/JP2020/023268

§ 371 Date: Dec. 8, 2022

(51) Int. Cl. G06V 10/764; G06V 40/20

(52) U.S. Cl. CPC G06V 10/764; G06V 40/20

(57) ABSTRACT

An intention detection device 1X includes a preprocessor 21X, a motion pattern/object relation identifier 22X and a detector 23X. The preprocessor 21X is configured to generate preprocessed data associated with a human and a relevant object by processing a detection signal outputted by a sensor. The motion pattern/object relation identifier 22X is configured to identify a motion pattern of the human and a relation between the human and the object based on the preprocessed data. The detector 23X is configured to detect at least one of an activity, a gesture or a predicted step regarding the human based on the identified motion pattern and the identified relation able to integrate and provide lexical descriptions of the at least one of the activity, the gesture or the predicted step.

### TECHNICAL FIELD

The present invention relates to an intention detection device, an intention detection method and a computer-readable storage medium.

### BACKGROUND ART

As we notice the trend to adapt technical systems better to human needs, a system is introduced that detects the relevant aspect of intention of a person by detecting the behavior of the person for the purpose to contribute to the control of a system by a human. For example, PL 1 discloses a system which determines intention of a user based on the latest action of the user and executes a process based on the intention of the user. PL2 discloses an inference system which determines the intension based on an intention knowledge base and which updates the intention knowledge base based on the feedback on the action that is determined by the intension.

### CITATION LIST

### Patent Literature

[PL 1] Japanese Patent Application Laid-open under No. 2019-079204

[PL 2] Japanese Patent Application Laid-open under No. 2005-100390

### SUMMARY OF INVENTION

### Technical Problem

PL1 and PL2 requires a high quality of intention knowledge base or supervised learning to detect the human's intention. However, it could be a burden on a user to prepare such knowledge base or perform supervised learning in advance.

One example of an object of the present invention is to provide an intention detection device, an intention detection method and a computer-readable storage medium capable of suitably detecting human intention for the purpose of contributing to the control of a (technical) system by a human.

### Solution to Problem

As one mode of an intention detection device, there is provided an intention detection device including:

a preprocessor configured to generate preprocessed data associated with a human and a relevant object by processing a detection signal outputted by a sensor;

a motion pattern/object relation identifier configured to identify a motion pattern of the human and a relation(-ship) between the human and the object based on the preprocessed data; and

a detector configured to detect at least one of an activity, a gesture or a predicted step regarding the human based on the identified motion pattern and the identified relation able to integrate and provide lexical descriptions of the at least one of the activity, the gesture or the predicted step.

As one mode of a control method, there is provided a control method including:

generating preprocessed data associated with a human and a relevant object by processing a detection signal outputted by a sensor;

identifying a motion pattern of the human and a relation(-ship) between the human and the object based on the preprocessed data; and

detecting at least one of an activity, a gesture or a predicted step regarding the human based on the identified motion pattern and the identified relation able to integrate and provide lexical descriptions of the at least one of the activity, the gesture or the predicted step.

As one mode of a computer-readable storage medium, there is provided a non-transitory computer-readable storage medium storing instructions that, when executed by a processor, cause the processor to:

generate preprocessed data associated with a human and a relevant object by processing a detection signal outputted by a sensor;

identify a motion pattern of the human and a relation(-ship) between the human and the object based on the preprocessed data; and

detect at least one of an activity, a gesture or a predicted step regarding the human based on the identified motion pattern and the identified relation able to integrate and provide lexical descriptions of the at least one of the activity, the gesture or the predicted step.

### Advantageous Effect of Invention

According to the invention, it is possible to suitably detect human intention.

### BRIEF DESCRIPTION OF DRAWINGS

FIG. 1 is a block diagram schematically illustrating a configuration of an intention detection system according to a first example embodiment.

FIG. 2 illustrates an example of an overview of the process executed by an intention detection device.

FIG. 3 schematically illustrates time charts of activity, gesture, motion primitives and motion patterns to be detected by the intention detection device.

FIG. 4 illustrates a functional block diagram of a processor of the intention detection device.

FIG. 5 illustrates the block diagram of a motion pattern/object relation identifier.

FIG. 6 illustrates the specific example of processing of a dynamic variation signal.

FIG. 7 illustrates the overview of the encoding of human pose and object relation.

FIG. 8 illustrates the block diagram of a local intention detector.

FIG. 9 indicates an example of a flowchart indicative of the local intention detection process executed by the intention detection device.

FIG. 10 illustrates a block diagram of an intention detection device according to a second example embodiment.

FIG. 11 illustrates an intention detection system according to a third example embodiment.

FIG. 12 illustrates an intention detection device according to a fourth example embodiment.

FIG. 13 illustrates a flowchart according to a fourth embodiment.

### DESCRIPTION OF EMBODIMENTS

### First Example Embodiment

(1) System Configuration

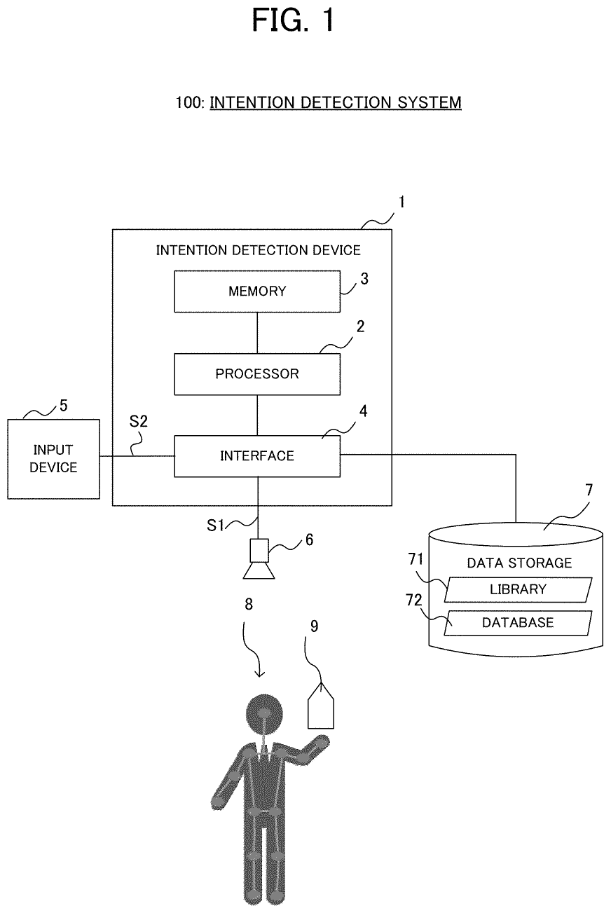

FIG. 1 is a block diagram schematically illustrating a configuration of an intention detection system 100 according to a first example embodiment of the invention. The intention detection system 100 is a system capable of performing unsupervised or semi-supervised learning of human motion patterns and sequences and thereby detecting human intention. As illustrated, the intention detection system 100 includes an intention detection device 1, an input device 5, a sensor 6 and a data storage 7.

The intention detection device 1 detects human intention through unsupervised or semi-supervised learning of motion patterns and sequence of a target human 8 by using a detection signal “S1” supplied from the sensor 6 and an input signal “S2” supplied from the input device 5. In order to detect the human intention, the intention detection device 1 detects not only motion patterns of the target human 8 but also one or more relevant object 9 which is relevant to the target human 8 and a relation(-ship) (hereinafter, referred to as object relation”) between the target human 8 and the relevant object 9. Specific examples of the object relation include “FAR”, “CLOSE”, “ALMOST” and “HOLD” depending on the distance between the target human 8 and the relevant object 9. It is noted that this application considers an intention detection system 100 with an advanced level of interpretability and that objects close to an acting person are considered to be potentially relevant to derive human intention (including “local intention” and “global intention” to be explained later).

It is noted that, after human intention detection, the intention detection device 1 may further control a robot or any other electronic product to assist the human in accordance with the detected intention. In this case, for example, by generating and supplying a driving signal to the robot or other electronic product, the intention detection device 1 may assist a task such as an intervention task (police, fire brigade, . . . ), a maintenance task and an object moving task.

Input device 5 is one or more user interface for accepting various kinds of commands and data from a user of the intention detection system 100. Examples of the input device 5 include keys, switches, buttons, a remote controller and a sound input device. The sensor 6 is one or more sensor needed for the intention detection device 1 to detect the human intention and generates detection signal S1 by sensing the target human 8 subjected to intension detection and the relevant object 9 in the surroundings of the target human 8. The sensor 6 supplies the detection signal S1 to the intention detection device 1. Examples of the sensor 6 include an imaging device such as a camera and a depth sensor such as a lidar (Light Detection and Ranging or Laser Imaging Detection and Ranging). The sensor 6 may be provided at a robot or other electrical products controlled by the intention detection device 1.

The data storage 7 includes a non-volatile memory needed for the intention detection device 1 to perform various processes. For example, the data storage 7 includes a library 71 and a database 72.

The library 71 is used for classification of motion patterns of the target human 8 and is gradually enhanced through unsupervised or semi-supervised learning. For example, each single entry of the library 71 contains:

an index indicative of a class of motion patterns;

a class-specific criterion for determining if a motion pattern belongs to the class; and

an associated lexical description with respect to the class.

In some embodiment, the library 71 further includes a library associated with classification of objects and/or a library associated with classification of object relations.

The database 72 is one or more database for incrementally building up the library 71. Examples of the database 72 include a book database with lexical descriptions and definitions of motion patterns. The book database may be a textual database with text from book or other documents which are available in a process-able form and describe activities of humans in relation with their environment. The database 72 may also include a database with lexical descriptions and definitions of relations between an object and a human, and a database with lexical descriptions and definitions of objects.

It is noted that the library 71 and the database 72 may be separately stored on different devices. In this case, the data storage 7 is realized by two or more devices. Besides, in some embodiments, the library 71 may be stored on the memory 3 of the intention detection device 1 and the database 72 may be stored on one or more server devices which can exchange data with the intention detection device 1 through the internet.

Next, a description will be given of the hardware configuration of the intention detection device 1. The intention detection device 1 includes a processor 2, a memory 3 and an interface 4.

The processor 2 is one or more processors such as a CPU (Central Processing Unit), a GPU (Graphics Processing Unit) and a quantum computer processor and executes various processing necessary for the intention detection device 1. The processor 2 executes a program preliminarily stored in the memory 3 or the data storage 7 thereby to achieve the various processing. The memory 3 typically includes a ROM (Read Only Memory) and a RAM (Random Access Memory), and stores necessary programs to be executed by the processor 2. The memory 3 also serves as a work memory during execution of various processing by the processor 2.

The interface 4 executes the interface operation with external devices such as the input device 5, the sensor 6 and the data storage 7. For example, the interface 4 provides the processor 2 with detection signals outputted by sensor 6 and data extracted from the data storage 7.

(2) Overview of Process

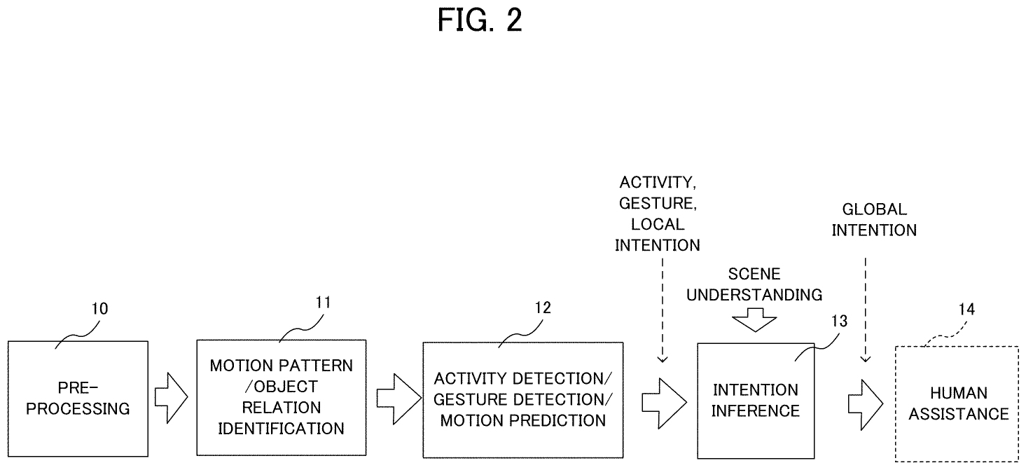

FIG. 2 illustrates an example of an overview of the process executed by the intention detection device 1.

First, the intention detection device 1 performs a pre-processing 10 based on the output of the sensor 6. In this case, the intention detection device 1 generates preprocessed data by processing the time-series detection signal S1. The intention detection device 1 generates preprocessed data regarding both of the target human 8 and relevant object 9.

Then, on the basis on the preprocessed data, the intention detection device 1 performs a motion pattern/object relation identification 11 through the classifications by unsupervised or semi-supervised learning with gradually enhanced library 71. As a part of the process of the motion patterns/object relation identification 11, the intention detection device 1 automatically derives relevant timing and automatically partitions the preprocessed data to identify each motion pattern.

Thereafter, the intention detection device 1 performs an activity detection/gesture detection/motion prediction 12. Thereby, the intention detection device 1 detects the activity, gesture and predicted motion of the target human 8. The predicted motion of the target human 8 corresponds to the local intention of the target human 8. The term “local intention” is an immediate expression of human intention and can be inferred from a certain posture and movement of the arm and vicinity to an object of this kind.

Furthermore, the intention detection device 1 performs an intention inference 13 thereby to detect the global intention of the target human. The term “global intention” is a longer-term expression of human intention and needs a higher level of understanding from the scene than the local intention does. In cases of eating dinner, the local intention may be “reaching for a knife” and the global intention may be “preparing a meal in order to be replete”. The intention detection device 1 also performs scene understanding based on the detection signal S1 as necessary to perform the intention inference 13.

Then, the intention detection device 1 performs human assistance 14 by a (technical) system in accordance with the detected global intention. For example, the intention detection device 1 controls a robot or other electric product(s) to assist the task which the target human 8 is working on. In other words, the intention detection device 1 may determine a next operation of a robot and the like based on the detected global intention and control the device based on the determined next operation.

To get an idea, how the intention result of the intention detection device 1 is used, a situation where a person wants to bring back a tool used for work to its appropriate storage place is considered. In this situation, the intention detection device 1 detects the intention “bringing tool to appropriate storage”. The control system of the robot translates this intention result into operational sequences such as “determine space coordinates of tool”, “move to position of tool”, “hold the tool”, “move to storage place of tool” and “put down tool there”.

It is noted that the intention detection device 1 may not necessarily perform the human assistance 13. For example, the intention detection device 1 may output the result of the intention inference 13 (and the activity detection/gesture detection/motion prediction 12) by a display or a speaker. In another example, the intention detection device 1 may provide the above result to an external device.

It is noted that the intention detection system 100 can start the process without the library 71 prepared in advance regarding motion, gesture and activity. It may lead to some misclassifications or ambiguity at the beginning, however, it can automatically structure itself. After a while and in order to improve the detection accuracy of the intention, the intention detection system 100 may need some user input depending on the application.

Instead, the intention detection system 100 can start the process with the library 71 with some initial entries indicative of already classified and labeled motion patterns and sequences which are already assigned to the correct gesture and activity class. In still another example, the intention detection system 100 can start the process with a fully configured library 71 containing all motion patterns and with no need for additional training or labelling.

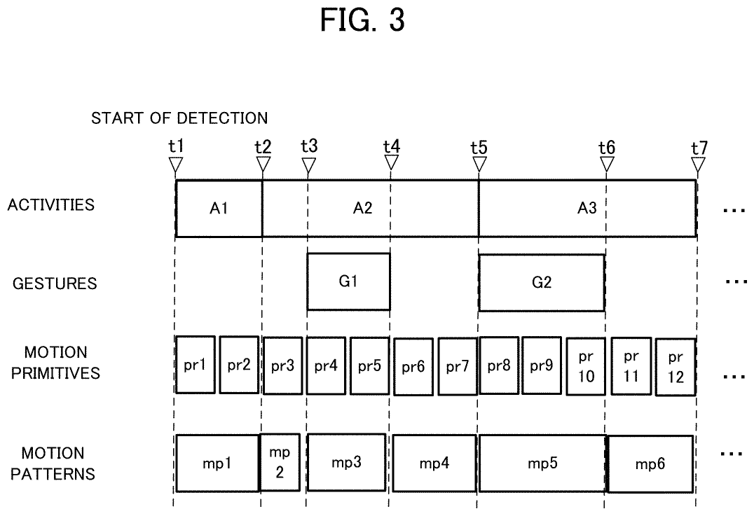

FIG. 3 schematically illustrates time charts of activities, gestures, motion primitives and motion patterns to be detected by the intention detection device 1.

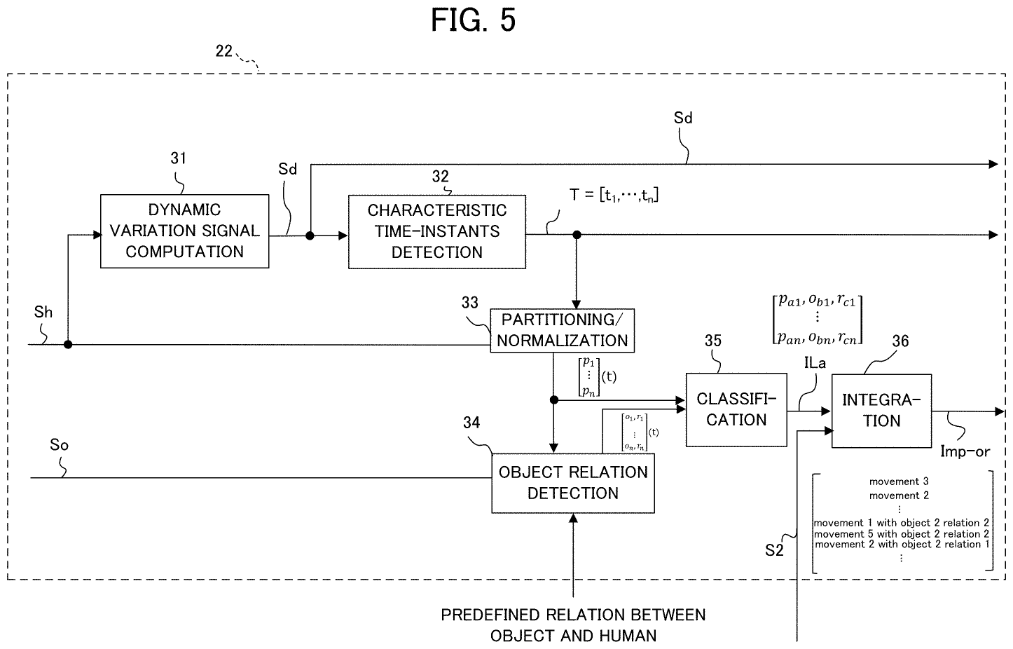

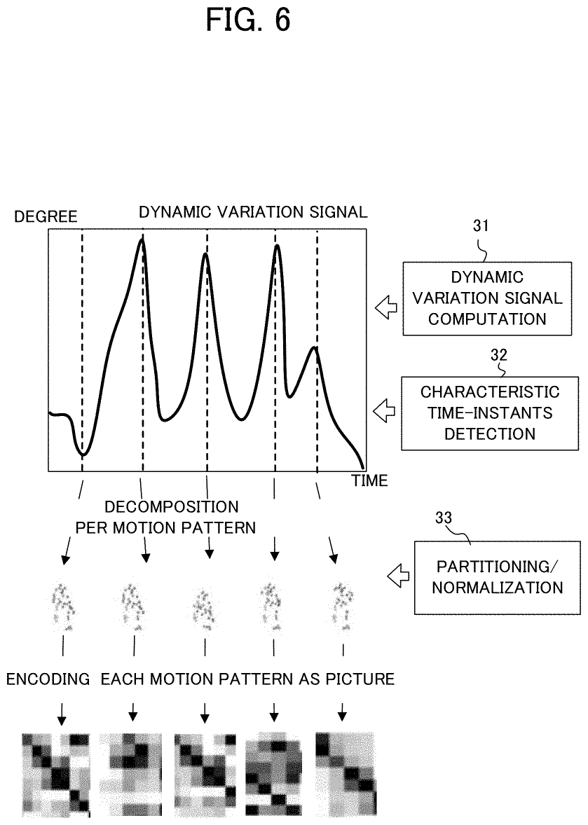

According to FIG. 3, the intention detection device 1 detects eight motion patterns “mp1” to “mp6” during a time period (target time period) from the time “t1” to the time “t7”. It is noted a single motion pattern includes at least one motion primitive, wherein there are twelve motion primitives “pr1” to “pr12” during the target time period. It is also noted that the intention detection device 1 detects the motion patterns mp1 to mp8 by partitioning the target time period from the time t1 to the time t8. The detail of this partitioning process will be described in FIG. 5 and FIG. 6.

On the basis of detected motion patterns, the intention detection device 1 detects two gestures “G1” and “G2” during the target time period. The term “gesture” herein indicates one or more motion pattern with a high degree of predictive power for predicting the motion of the target human 8. Namely, a gesture consists of at least one motion pattern for one activity and gestures are motion patterns that have higher predictive power than other motion patterns within the time interval of one activity. Thus, it could happen that the same motion pattern is classified as a gesture in one activity and as not a gesture in another activity.

For example, a case is considered herein that the activity A2 is “cutting bread”, the motion pattern mp2 is “raising arm”, the motion pattern mp3 is “moving arm up and down with holding knife” and the motion pattern mp4 is “moving arm to initial position”. In this case, since the motion pattern “moving arm up and down with holding knife” has a high degree of prediction power, the intention detection device 1 regards the motion pattern mp3 as a gesture (gesture G1). In this case, as of the time t4, the intention detection device 1 can predict motion pattern mp4 and other future motion pattern(s) based on the detected gesture G1.

(3) Functional Block Diagram

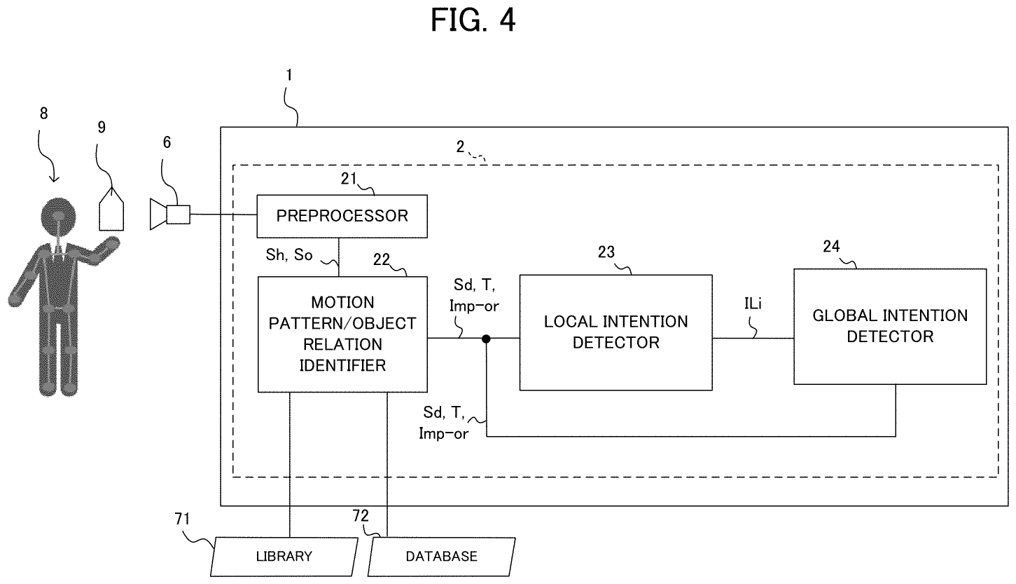

FIG. 4 illustrates a functional block diagram of the processor 2 of the intention detection device 1. The process functionally includes a preprocessor 21, a motion pattern/object relation identifier 22, a local intention detector 23 and a global intention detector 24. The preprocessor 21 performs the preprocessing 10 in FIG. 2, the motion pattern/object relation identifier 22 performs the motion pattern/object relation identification 11, the local intention detector 23 performs the activity detection/gesture detection/motion prediction 12 and the global intention detector 24 performs the intention inference 13. An element which performs the human assistance 14 is not shown herein. In FIG. 4, components which exchange data with each other are connected by solid line. It is noted that the combinations of components which exchange data with each other are not limited to the combinations described in FIG. 3. It is true for other block diagrams mentioned later.

The preprocessor 21 generates a human preprocessed signal “Sh” of the target human 8 by processing the time-series detection signal S1 outputted by the sensor 6 (e.g., camera) which senses the target human 8. For example, the preprocessor 21 detects the position of specific joints of the target human as virtual points from an image outputted by the sensor 6 and tracks each of virtual points through images outputted in sequences by the sensor 6. The human preprocessed signal Sh may be any other feature data for detecting the movement of the target human 8. The preprocessor 21 may choose any approach from various kinds of approaches for generating the human preprocessed signal Sh.

The preprocessor 21 also generates the object preprocessed signal “So” associated with the relevant object 9 by processing the time-series detection signal S1. For example, the preprocessor 21 recognizes the existence of the relevant object 9 based on the detection signal S1 (e.g., time-series images) outputted by the sensor 6 through an approach selected from various kind of object detection approaches. In this case, the preprocessor 21 also recognizes the type or the ID (identification) of the relevant object 9, the pose of the relevant object 9 and the distance between the relevant object 9 and the target human 8. Then, the preprocessor 21 generates relevant object signals So indicative of the type (or ID), the pose (or orientation), the distance and the like regarding the relevant object 9. The preprocessor 21 supplies the human preprocessed signal Sh and the object preprocessed signal So to the motion pattern/object relation identifier 22. It is noted that the object preprocessed signal So may be any feature data of the object 9 needed to recognize the type (or ID), the pose (or orientation), the distance. In this case, the motion pattern/object relation identifier 22 recognizes the type (or ID), the pose (or orientation), the distance based on the object preprocessed signal So. The human preprocessed signal Sh and the object preprocessed signal So constitute an example of “preprocessed data” according to this disclosure.

The motion pattern/object relation identifier 22 identifies the motion patterns and object relation through the classifications by unsupervised or semi-supervised learning with gradually enhanced library 71.

Specifically, the motion pattern/object relation identifier 22 generates dynamic variation signal “Sd” and timing information “T” for further process. The dynamic variation signal Sd indicates the amount of motion of the human body. For example, the dynamic variation signal Sd can be computed by calculating a difference (in time) of matrices that are the human preprocessed data Sh with respect to multiple points (e.g., joints) and mapping the matrices to a scalar value. The timing information T indicates a sequence of time-instants for determining each time slot of each motion pattern.

Besides, the motion pattern/object relation identifier 22 generates motion patterns and object relation (referred to as “mp-or”) information “Imp-or”. The mp-or information Imp-or indicates lexical descriptions of the mp-or patterns. The motion pattern/object relation identifier 22 may accept a user input to generate the mp-or information Imp-or. The motion pattern/object relation identifier 22 supplies the dynamic variation signal Sd, the timing information T and the mp-or information Imp-or to the local intention detector 23.

On the basis of the dynamic variation signal Sd, timing information T and the mp-or information Imp-or, the local intention detector 23 detects activity, gesture and predicted motion which are related to the local intention of the target human 8. Then, the local intention detector 23 supplies the global intention detector 24 with information (referred to as “local intention information ILi”) associated with the local intension including the detected activity, detected gesture and predicted motion. It is noted that, through unsupervised or semi-supervised learning, the local intention detector 23 determines the length of the activity via object relations.

The global intention detector 24 detects the global intension of the target human 8 based on the local intention information ILi, the dynamic variation signal Sd, the timing information T and the mp-or information Imp-or. The global intention detector 24 finds the latent representation that captures most of the long-term behavior of the target human 8 and is robust against single motion pattern misclassification or not relevant motion pattern. In some embodiments, the global intention detector 24 may be realized based on the generative adversarial network theory. In this case, the global intention detector 24 includes a generator and a discriminator and the training is done in a way that the influence of several changed motion patterns on the detected gesture and activity is minimized to the extent possible. In this training, various error functions may be used such as: an error function that describes how effectively the system alters pattern and masks the motion patterns so that activity and gesture would be difficult to reconstruct; and an error function that describes the deviation of the sequence of the motion patterns from the altered sequence of the motion patterns. In this case, the preprocessor 21, motion pattern/object relation identifier 22 and local intention detector 23 function as an encoder and the global intention detector 24 functions as a decoder. In this way, the intention detection system 100 has an encoding-decoding mechanism for long-term intention detection and is preferably integrated in a coder-encoder differentiator scheme.

It is noted that each component of the preprocessor 21, the motion pattern/object relation identifier 22, the local intention detector 23 and the global intention detector 24 can be realized by the processor 2 executing program(s), for example. Specifically, above each component can be realized through execution of program(s) stored in the memory 3 by the processor 2. In another example, each component may be realized by installing necessary program(s) stored in any non-volatile memory as necessary. It is also noted that each component is not limited to what is realized by a software program and that each component may be realized by controller corresponding to any combination selected from hardware, firmware and software. It is also noted that each component may be realized by use of an integrated circuit which can be programmed by a user such as a FPGA (Field-Programmable Gate Array) and a microcomputer. The above-mentioned explanation can also be applied to other example embodiments to be described later.

(4) Detail of Motion Pattern and Object Relation Identifier

FIG. 5 illustrates the block diagram of the motion pattern/object relation identifier 22. The motion pattern/object relation identifier 22 mainly includes a dynamic variation signal computation block 31, a characteristic time-instants detection block 32, a partitioning/normalization block 33, an object relation detection block 34, a classification block 35 and an integration block 36.

The dynamic variation signal computation block 31 computes the dynamic variation signal Sd based on the human preprocessed signal Sh. For example, as the human preprocessed signal Sh, the dynamic variation signal computation block 31 generates a sequence of frames regularly sampled in time, wherein each frame includes the amount of movement with respect to each point (e.g., joint) detected from the target human 8.

The characteristic time-instants detection block 32 generates the timing information T by detecting the characteristic time-instants based on the dynamic variation signal Sd supplied from the dynamic variation signal computation block 31. Then, the characteristic time-instants detection block 32 supplies the timing information T indicative of detected characteristic time instants to other blocks.

The partitioning/normalization block 33 determines the partition of the human preprocessed signal Sh (i.e., preprocessed data) based on the timing information T supplied from the characteristic time-instants detection block 32. The partitioning/normalization block 33 also normalizes the human preprocessed signal Sh partitioned according to the timing information T. The partitioned and normalized human preprocessed signal Sh according to the timing information T=[t1, . . . , tn] is expressed herein as “[p1, . . . , pn]”, wherein each element of [p1, . . . , pn] corresponds to a single motion pattern. The sign “n” herein denotes a natural number. The partitioning/normalization block 33 supplies partitioned and normalized human preprocessed signal Sh to the classification block 35. The partitioning/normalization block 33 also supplies the timing information T to the object relation detection block 34.

It is noted that, due to the partitioning and the regular sampling of the frames of preprocessed data, multiple frames of preprocessed data are available for one motion pattern and that a predefined number of normalized frames are created by interpolation. It can be considered as a primitive version of time warping.

The object relation detection block 34 detects the object relation (i.e., relationship between the target human 8 and the relevant object 9) with respect to each time slot according to the timing information T. In this case, the object relation detection block 34 acquires information on predefined relation between the target human 8 and the relevant object 9 from the database 72. Then, the object relation detection block 34 detects the object relation by analyzing the object preprocessed signal So with reference to the above information. Hereinafter, “[o1, . . . , on]” stands for information regarding the relevant object 9 outputted by the object relation detection block 34 during the time period [t1, . . . , tn], and “[r1, . . . , rn]” stands for information regarding the object relation outputted by the object relation detection block 34 during the same time period.

The classification block 35 classifies motion patterns and object relations through unsupervised or semi-supervised learning with gradually enhanced library 71 using time warping. The classification block 35 may be based on a modified, enhanced version of random forest algorithm. The classification block 35 outputs, as a result of the classification, label information “ILa” associated with the class of the motion pattern, the relevant object and the object relation with respect to each timing defined by the timing information T. For, example, the classification block 35 outputs the class label of the potion pattern “Pai” (i=1, . . . n), the class label of the relevant object “obi” and the class label of the object relation “rci” as a result of a classification at the time instant “ti”. For example, each class label includes a class index and associated lexical description. In this case, the classification block 35 outputs the matrix of “p”, “o”, “r” to the integration block 36. In another example, the classification block 35 may output some graphical representation to the integration block 36 in order to make the annotation work easier.

The integration block 36 integrates the label information ILa that is the classification result outputted by the classification block 35 and the user input information according to the input signal S2 from the input device 5 thereby to generate the mp-or information Imp-or. Examples of the user input information include the lexical description of the mp-or pattern associated with the classification result. For example, the lexical description of the “Motion pattern n” may be specified by the user input information as “Raises right elbow”, and the lexical description of “motion pattern m” may be specified by the user input information as “Raises left elbow”. It is noted that lexical descriptions can be interpreted as vectors.

The user input information may be inputted in the middle of activities or may be inputted in an offline fashion. In the latter case, the process by the integration block 36 starts in an offline fashion, and after batch processing, additional user input information is entered. Later, the integration block 36 may ask for user input information in case of detecting ambiguity or missing information.

According to FIG. 5, after the above integration, the integration block 36 generates the mp-or information Imp-or indicating the following time-series mp-or patterns.

“movement 3”

“movement 2”

“movement 1 with object 2 relation 2”

“movement 5 with object 2 relation 1”

“movement 2 with object 2 relation 1”

FIG. 6 illustrates the specific example of the process by the dynamic variation signal computation block 31, the characteristic time-instants detection block 32 and the partitioning/normalization block 33.

First, the dynamic variation signal computation block 31 acquires the human preprocessed signal Sh and computes the dynamic variation signal Sd. Then, the characteristic time-instants detection block 32 detects the characteristic time-instant by detecting, for example, the local minima (may also include local maxima) of the human preprocessed signal Sh. Then, based on the result by the characteristic time-instants detection block 32, the partitioning/normalization block 33 decomposes the human preprocessed signal Sh per motion pattern. It is noted that some kind of filtering may be performed to the dynamic variation signal Sd depending on how the dynamic variation signal is computed. Then, the partitioning/normalization block 33 encodes each motion pattern as a picture with primitive method for time warping (normalization).

It is noted that, in order to get better classification results at the classification block 35, the characteristic time-instants detection block 32 and the partitioning/normalization block 33 may use the feedback regarding the quality of the classification results on the process of partitioning. By using adaptation of the classification scheme, it is expected that the results improve.

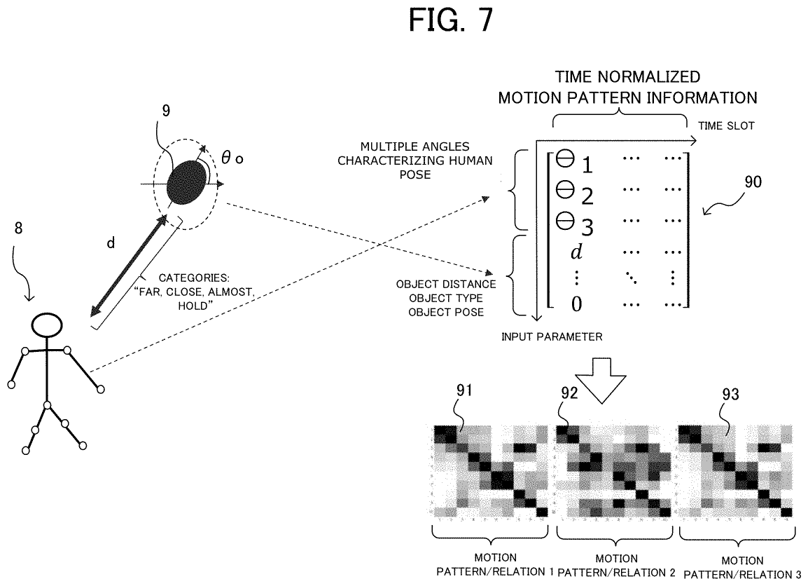

FIG. 7 illustrates the overview of the encoding of human pose and object relation. In FIG. 7, on the target human 8, there are circles corresponding to points where the dynamic variation signal Sd is computed.

In this case, the partitioning/normalization block 33 detects the pose of the target human 8 based on the human preprocessed data Sd with respect to each detection point of the target human 8 and encodes the pose by multiple angles characterizing the pose of the target human 8. In contrast, the preprocessor 21 or the object relation detection block 34 detects the type of the relevant object 9, the pose of the relevant object 9 and the distance “d” between the target human 8 and the relevant object 9. In FIG. 7, the angle “θo” characterizing the pose of the relevant object 9 is at least detected. The distance d may be categorized and expressed by the category. In FIG. 7, the distance d is categorized into “CLOSE” selected from four categories “FAR”, “CLOSE”, “ALMOST” and “HOLD”.

The matrix 90 is an example of a combination of the outputs by the partitioning/normalization block 33 and the object relation detection block 34. The matrix 90 indicates a time normalized motion pattern information including information on the motion pattern, the relevant object and the object relation. The matrix 90 is converted into a picture and it is used for the classification by the classification block 35. Examples of the above picture are shown as the pictures 91 to 93. The pictures 91 to 93 indicate different combinations of the motion pattern and object relation.

As described above, the motion pattern/object relation identifier 22 uses the dynamic variation signal Sd and timing information T and obtains label information ILa by executing classification algorithm for further processing. This allows for quantitative labels automatically derived through classification algorithm without any further linguistic interpretation in order to be later replaced by linguistic expressions.

(5) Detail of Local Intention Detector

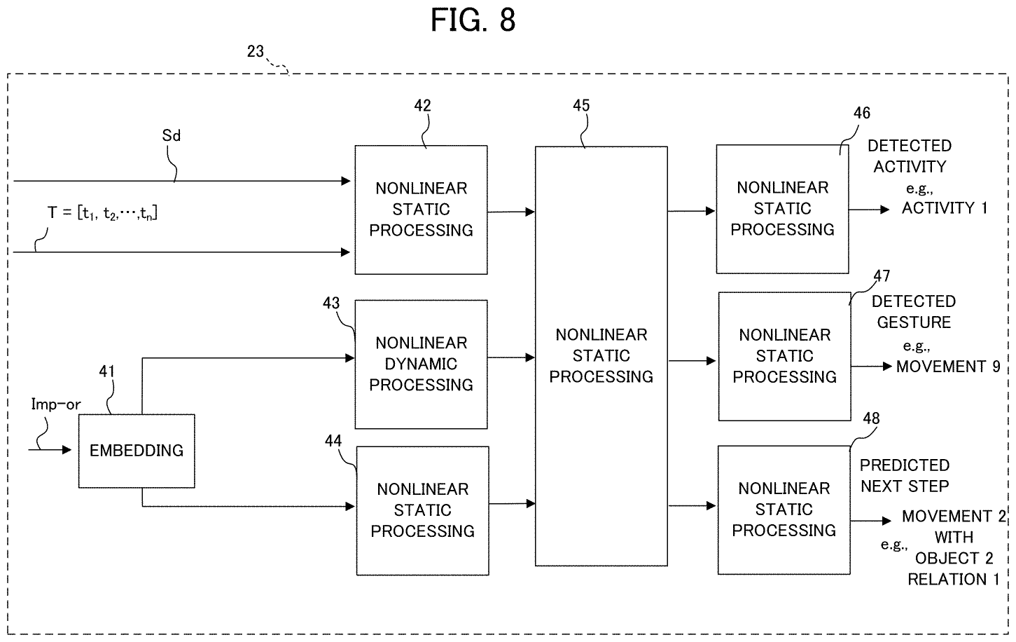

FIG. 8 illustrates the block diagram of the local intention detector 23. The local intention detector 23 mainly includes an embedding block 41, a nonlinear dynamic processing block 43 and six nonlinear static processing blocks 42, 44 to 48.

The embedding block 41 converts the mp-or information Imp-or into a numerical format for further processing. Specifically, the embedding block 41 maps the lexical description (i.e., words) indicated by the mp-or information Imp-or into a vector that is a series of numbers. By using the properties of higher order mathematical spaces, the relationship between words (e.g., how close they are in their meanings) can be expressed. The embedding block 41 may be according to Word2Vec or any other natural language process model. The quality of the embedding is essential for further processing.

The nonlinear static processing blocks 42, 44 to 48 perform forward processing with several layers without using additional memory for feedback loops and thereby detect intrinsic relation between different steps. Examples of the nonlinear static processing blocks 42, 44 to 48 include a multiplayer perceptron network and an auto associative network.

The nonlinear static processing block 42 performs nonlinear static processing of the dynamic variation signal Sd and the timing information T outputted from the motion pattern/object relation identifier 22 and supplies the result of the processing to the nonlinear static processing block 45. The nonlinear static processing block 44 performs nonlinear static processing of the numerical vector outputted by the embedding block 41 and supplies the result of the processing to the nonlinear static processing block 45. The nonlinear static processing block 45 performs nonlinear static processing (second nonlinear static processing) of the data outputted (derived) from the nonlinear static processing block 42, the nonlinear dynamic processing block 43 and the nonlinear static processing block 44. Then, the nonlinear static processing block 45 supplies the result of the processing to the nonlinear static processing block 46, the nonlinear static processing block 47 and the nonlinear static processing block 48, respectively.

On the basis of the output data from the nonlinear static processing block 45, the nonlinear static processing block 46 is configured to output the lexical descriptions of the detected activity (e.g., “ACTIVITY 1”) through nonlinear static processing. The nonlinear static processing block 47 is configured to output the lexical descriptions of the detected gesture (e.g., “MOVEMENT 9”) based on the output data from the nonlinear static processing block 45 through nonlinear static processing. Through nonlinear static processing, the nonlinear static processing block 48 is configured to output the lexical descriptions of the predicted steps (i.e., predicted next movement, e.g., “MOVEMENT 2 WITH OBJECT 2 RELATION 1”) which the target human 8 will take based on the output data from the nonlinear static processing block 45.

The nonlinear dynamic processing block 43 detects a sequence of occurring with a feedback function by using memory for feedback loops. The examples of the nonlinear dynamic processing block 43 include a recurrent neural network. The nonlinear dynamic processing block 43 receives the numerical vector outputted by the embedding block 41 and supplies the result of the process to the nonlinear static processing block 45.

A description will be given of supplemental explanation of the training of the local intention detector 23. If the local intention detector 23 (i.e., intention detection system 100) is trained on a video sequence in an off-line fashion, then the local intention detector 23 is not be provided with the next motion pattern since this information is available. In this case, gesture and activity are more demanding. The local intention detector 23 could be provided as a first solution by user-input, which is semi-supervised learning because it is only taught activity and gesture. However, in a later implementation, it is envisaged to automate to a certain degree even this part. The scheme for automation of the local intention detector 23 is performed together with the training of the global intention detector 24.

(6) Process Flow

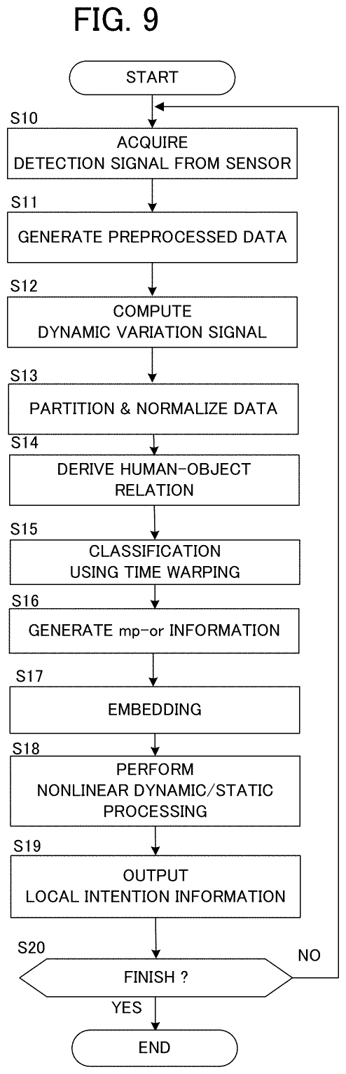

FIG. 9 indicates an example of a flowchart indicative of the local intention detection process executed by the intention detection device 1.

First, the intention detection device 1 acquires the detection signal S1 from the sensor 6 (step S10). Then, the intention detection device 1 generates the preprocessed data from the detection signal S1 (step S11). Specifically, the intention detection device 1 generates the human preprocessed signal Sh relevant to the target human 8 and the object preprocessed signal So relevant to the relevant object 9.

Next, the intention detection device 1 computes the dynamic variation signal Sd based on the human preprocessed signal Sh (step S12). Then, the intention detection device 1 partitions and normalizes the human preprocessed signal Sh (step S13). In this case, by detecting characteristic time-instants based on the dynamic variation signal Sd, the intention detection device 1 divides the human preprocessed signal Sh into data with respect to each motion pattern.

Then, the intention detection device 1 derives an object relation between the target human 8 and the relevant object 9 based on the object preprocessed signal So and the result at step S13 (step S14). Thereafter, the intention detection device 1 performs the classification using time warping (step S15). In this case, the intention detection device 1 classifies the motion pattern, the relevant object 9 and the object relation with respect to each time slot. Then, the intention detection device 1 generates mp-or information Imp-or that is a lexical description regarding classified motion pattern and object relation (step S16). Then, the intention detection device 1 embeds the mp-or information Imp-or (step S17). Thereby, the intention detection device 1 converts the mp-or information Imp-or to a numerical format. After that, the intention detection device 1 performs nonlinear dynamic/static processing (step S18). Thereby, the intention detection device 1 detects the sequence of the occurring and finds the intrinsic relationship between different steps. Then, as a result of step S18, the intention detection device 1 outputs the local intention information ILi indicative of the detected action, detected gesture and predicted motion (step S19). Thereafter, the global intention detector 24 of the intention detection device 1 detects global intention of the target human 8 based on the local intention information ILi outputted at step S19.

The intention detection device 1 determines whether or not to finish the local intention detection process (step S20). If the intention detection device 1 determines that the intention detection device 1 should finish the local intention detection process (step S20; Yes), the intention detection device 1 terminates the local intention detection process according to the flowchart. If the intention detection device 1 determines that the intention detection device 1 should not finish the process (step S20; No), the intention detection device 1 goes back to the process at step S10.

(7) Advantageous Effects

A description will be given of advantageous effects according to the first example embodiment.

The intention detection system 100 has a special architecture and processing structure capable of almost unsupervised pattern and sequence learning. Besides, the intention detection system 100 partitions the dynamic motion of a human being into basic motion pattern of variable time length and derives object relation, by transforming (i.e., regularizing, normalizing and time warping) the data for each basic pattern. Thereby, the intention detection system 100 can determine immediate needs (i.e., local intention) and longer-term needs (i.e., global intention) and intention of a human interacting with/operating a machine with high quality (understood as high level of intuitiveness) and in a robust way for the purpose to release burden of command instruction.

The intention detection system 100 may be applied to robotics, assistance systems, collaborative robots, machine user interfaces. For specific example, the intention detection system 100 may be applied to tasks that need user input related to computer/machine/robot operating systems, intervention tasks, maintenance tasks, general operation tasks, object moving tasks. However, the present invention is not necessarily limited to these fields.

### Second Example Embodiment

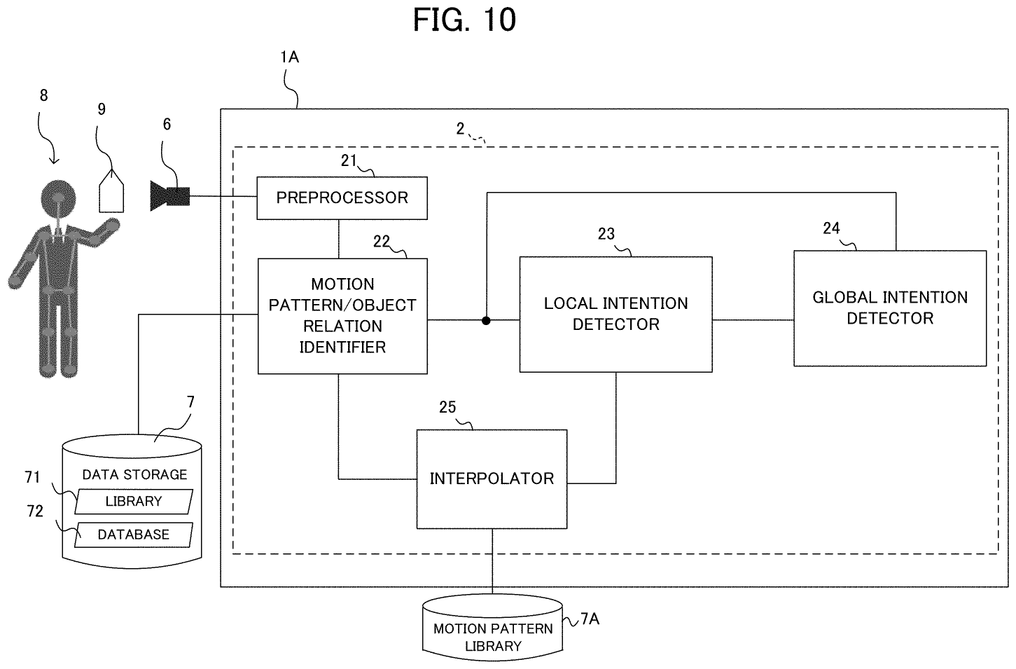

FIG. 10 illustrates a block diagram of an intention detection device 1A according to the second example embodiment. The intention detection device 1A is different from the intention detection device 1 in that the intention detection device 1A further includes an interpolator 25 which refers to a motion pattern library 7A. Hereinafter, the same reference numbers as the first example embodiment are allocated to the same elements as the first example embodiment and the explanation thereof will be omitted.

The motion pattern library 7A includes sentences (i.e., lexical descriptions or language labels) regarding possible motion patterns. The motion pattern library 7A may be stored on the data storage 7 or other external device(s).

The interpolator 25 searches the motion pattern library 7A for textual (lexical) descriptions of missing classification patterns if there is no lexical description of some motion patterns relevant to the local intention (including gesture and activity) detected by the local intention detector 23. The interpolator 25 also calculates a probability or gives other scores for missing motion pattern description. Besides, the interpolator 25 learns new motion pattern labels and evaluates the consistency of the motion pattern description over time.

For example, it is assumed herein that the local intention detector 23 recognizes the following sequence of motion:

### “Walks”,

“Walks towards, shelf”,
“Raises arm”,
“Reaches for, close to book”,
“Lowers arm, holds book”,
“Grasp both hands hold book”,
“Unknown motion pattern, hold book” and
“Grasp both hands hold book”.

Then, after receiving the information regarding the above sequence from the local intention detector 23, the interpolator 25 infers, with reference to the motion pattern library 7A, that the unknown motion pattern is “reading and holding, the book, with two arms”. Then, the interpolator 25 supplies the result to the motion pattern/object relation identifier 22.

According to the second example embodiment, the interpolator 25 works in such a situation that the local intention detector 23 detects the local intention including the activity and gestures of the target human 8, however, some motion patterns have no lexical description (i.e., language label). In such a situation, the interpolator 25 searches for automatically the right lexical description and evaluates the consistency thereof over time. Thereby, the intention detection device 1A can acquire missing lexical description of motion patterns and increase the detection accuracy of the local intention including the activity and gestures of the target human 8.

### Third Example Embodiment

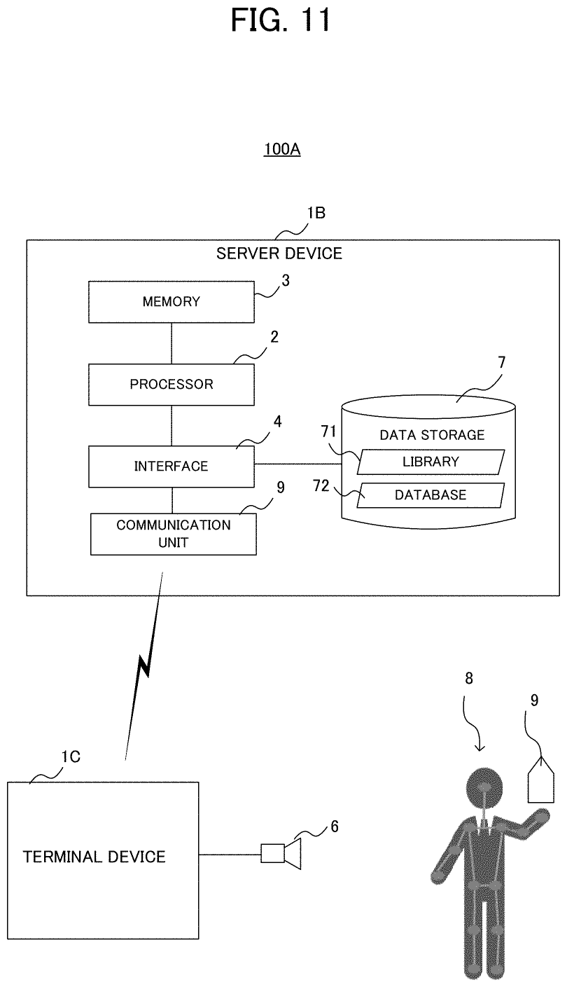

FIG. 11 illustrates an intention detection system 100A according to the third example embodiment. The intention detection system 100A includes a server device 1B which functions as intention detection device and a terminal device 1C which is equipped with a user input function, a data communication function and other functions. Hereinafter, the same reference numbers as the first example embodiment are allocated to the same elements as the first example embodiment and the explanation thereof will be omitted.

The server device 1B functions as the intention detection device 1 according to FIG. 1 and performs the intention detection. The server device 1B receives detection signals outputted by the sensor 6 via the terminal device 1C and executes processes as illustrates in FIG. 2. The server device 1B includes a processor 2, a memory 3, an interface 4, a data storage 7 and a communication unit 9 that is a communication interface. The processor 2, the memory 3, the interface 4 and data storage 7 in the server device 1B correspond to the processor 2, the memory 3, the interface 4 and the data storage 7 in the intention detection device 1 in FIG. 1, respectively. The communication unit 9 exchanges, with the terminal device 1C, data such as a detection signal by the sensor 6 and user input information generated by the terminal device 1C under the control of the processor 2.

It is noted that the server device 1B may be constituted by multiple devices. In this case, each of the multiple devices exchanges data with each other to execute preliminarily-allocated own task.

Even according to the third example embodiment, the server device 1B can suitably detect an intention of the target human 8.

### Fourth Example Embodiment

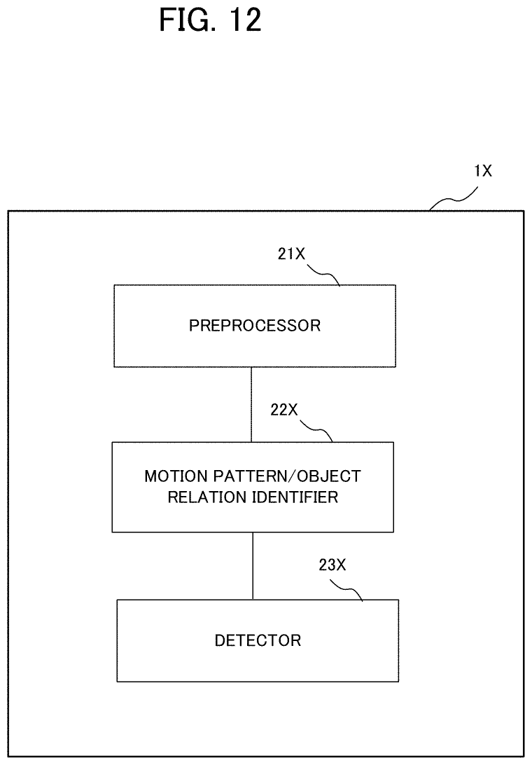

FIG. 12 illustrates an intention detection device 1X according to the fourth example embodiment. The intention detection device 1X includes a preprocessor 21X, a motion pattern/object relation identifier 22X and a detector 23X.

The preprocessor 21X is configured to generate preprocessed data associated with a human and a relevant object by processing a detection signal outputted by a sensor. For example, the preprocessor 21X can be realized by the preprocessor 21 according to any one of the first to third example embodiments.

The motion pattern/object relation identifier 22X is configured to identify a motion pattern of the human and a relation between the human and the object based on the preprocessed data. For example, the motion pattern/object relation identifier 22X can be realized by the motion pattern/object relation identifier 22 according to any one of the first to third example embodiments.

The detector 23X is configured to detect at least one of an activity, a gesture or a predicted step regarding the human based on the identified motion pattern and the identified relation able to integrate and provide lexical descriptions of the at least one of the activity, the gesture or the predicted step. For example, the detector 23X can be realized by the local intention detector 23 according to any one of the first to third example embodiments.

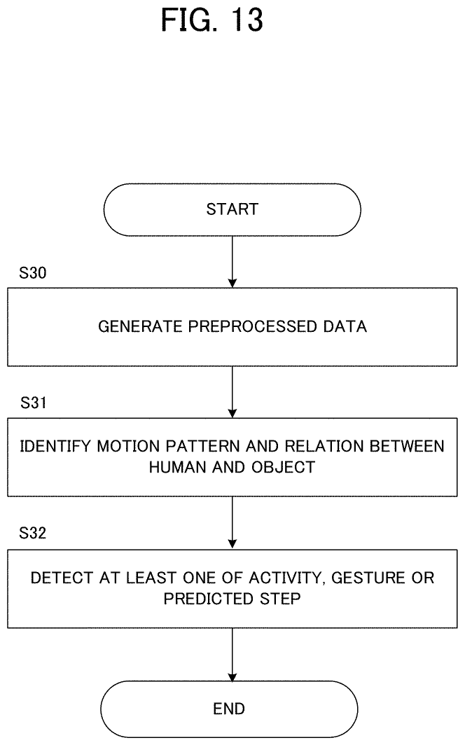

FIG. 13 illustrates a flowchart according to the fourth embodiment. The preprocessor 21X generates preprocessed data associated with a human and a relevant object by processing a detection signal outputted by a sensor (step S30). The motion pattern/object relation identifier 22X identifies a motion pattern of the human and a relation between the human and the object based on the preprocessed data (step S31). The detector 23X detects at least one of an activity, a gesture or a predicted step regarding the human based on the identified motion pattern and the identified relation able to integrate and provide lexical descriptions of the at least one of the activity, the gesture or the predicted step (step S32).

According to the fourth example embodiment, the intention detection device 1X can suitably detect the activity, gesture, and/or predicted step of the human in consideration of the relation between the human and the object.

For the above-mentioned example embodiments, a program can be stored on any one of various types of non-transitory computer readable media and be supplied to the processor 2 that is a computer. Examples of a non-transitory computer readable media include various types of tangible storage media. Examples of the non-transitory computer readable media include: a magnetic recording medium such as a flexible disc, a magnetic tape and a hard drive; a magneto-optical recording medium such as a magneto-optical disk; a CD-ROM; a CD-R; a CD-R/W; and a semiconductor memory such as a mask ROM, a PROM (Programmable ROM), an EPROM (Erasable PROM), a flash ROM and RAM. The above program may be supplied to the computer through any one of various types of transitory computer readable media. Examples of a transitory computer readable media include an electric signal, a light signal and an electromagnetic ray. The transitory computer readable media can supply the program to the computer via an electric wire, a wired communication path and/or a wireless communication path.

The above-described example embodiments can be partially or entirely expressed by, but is not limited to, the following Supplementary Notes.

(Supplementary Note 1)

An intention detection device comprising:

a preprocessor configured to generate preprocessed data associated with a human and a relevant object by processing a detection signal outputted by a sensor;

a motion pattern/object relation identifier configured to identify a motion pattern of the human and a relation(-ship) between the human and the object based on the preprocessed data; and

a detector configured to detect at least one of an activity, a gesture or a predicted step regarding the human based on the identified motion pattern and the identified relation able to integrate and provide lexical descriptions of the at least one of the activity, the gesture or the predicted step.

(Supplementary Note 2)

The intention detection device according to Supplementary Note 1,

wherein the motion pattern/object relation identifier performs classification of the motion pattern and the relation by unsupervised or semi-supervised learning.

(Supplementary Note 3)

The intention detection device according to Supplementary Note 2,

wherein the motion pattern/object relation identifier maps the motion pattern and the relation belonging to the same class to the same lexical description through the classification.

(Supplementary Note 4)

The intention detection device according to Supplementary Note 3,

wherein the motion pattern/object relation identifier gradually enhances a library through the unsupervised or semi-supervised learning, the library at least containing with respect to each class of the motion pattern and the relation:

a criterion for determining a class of the motion pattern and the relation;

and a lexical description of the class.

(Supplementary Note 5)

The intention detection device according to Supplementary Note 1,

wherein the motion pattern/object relation identifier

generates a dynamic variation signal from the preprocessed data and

partitions and normalizes the preprocessed data by detecting characteristic time-instants based on the dynamic variation signal to identify the motion pattern.

(Supplementary Note 6)

The intention detection device according to Supplementary Note 1,

wherein the motion pattern/object relation identifier identifies a lexical description of the motion pattern and the relation, and

the detector converts the lexical description to data in a numerical format to detect the at least one of the activity, the gesture or the predicted step.

(Supplementary Note 7)

The intention detection device according to Supplementary Note 6,

wherein the detector performs nonlinear dynamic processing and nonlinear static processing of the data in the numerical format to detect the at least one of the activity, the gesture or the predicted step.

(Supplementary Note 8)

The intention detection device according to Supplementary Note 7,

the detector performs second nonlinear static processing of data derived from the nonlinear dynamic processing and the nonlinear static processing to detect the at least one of the activity, the gesture or the predicted step.

(Supplementary Note 9)

The intention detection device according to Supplementary Note 8,

wherein the detector performs the second nonlinear static processing further based on a dynamic variation signal generated from the preprocessed data and timing information regarding the motion pattern.

(Supplementary Note 10)

The intention detection device according to claim 1, further comprising

an interpolator configured to, if a lexical description of the motion pattern is unknown, search a motion pattern library for the lexical description and evaluate consistency of the lexical description over time.

(Supplementary Note 11)

An intention detection method comprising:

generating preprocessed data associated with a human and a relevant object by processing a detection signal outputted by a sensor;

identifying a motion pattern of the human and a relation(-ship) between the human and the object based on the preprocessed data; and

detecting at least one of an activity, a gesture or a predicted step regarding the human based on the identified motion pattern and the identified relation able to integrate and provide lexical descriptions of the at least one of the activity, the gesture or the predicted step.

(Supplementary Note 12)

A non-transitory computer-readable storage medium storing instructions that, when executed by a processor, cause the processor to:

generate preprocessed data associated with a human and a relevant object by processing a detection signal outputted by a sensor;

identify a motion pattern of the human and a relation(-ship) between the human and the object based on the preprocessed data; and

detect at least one of an activity, a gesture or a predicted step regarding the human based on the identified motion pattern and the identified relation able to integrate and provide lexical descriptions of the at least one of the activity, the gesture or the predicted step.

While the invention has been particularly shown and described with reference to example embodiments thereof, the invention is not limited to these embodiments. It will be understood by those of ordinary skilled in the art that various changes in form and details may be made therein without departing from the spirit and scope of the present invention as defined by the claims. All Patent literatures mentioned in this specification are incorporated by reference in its entirety.

### INDUSTRIAL APPLICABILITY

This invention can be used for robotics, intention detection systems, collaborative robots, electronic products and a controller such as a server device which controls them.

### REFERENCE SIGN LIST

1, 1A, 1X Intention detection device
1B Server device
1C terminal device

### 2 Processor

### 3 Memory

### 4 Interface

5 Input device

### 6 Sensor

7 Data storage
9 Communication unit

What is claimed is:

1. An intention detection device comprising:
at least one memory configured to store instructions; and
at least one processor configured to execute the instructions to:
generate preprocessed data associated with a human and a relevant object by processing a detection signal outputted by a sensor;
identify a motion pattern of the human and a relation(-ship) between the human and the object based on the preprocessed data; and
detect at least one of an activity, a gesture or a predicted step regarding the human based on the identified motion pattern and the identified relation able to integrate and provide lexical descriptions of the at least one of the activity, the gesture or the predicted step.

2. The intention detection device according to claim 1,
wherein the at least one processor is configured to execute the instructions to perform classification of the motion pattern and the relation by unsupervised or semi-supervised learning.

3. The intention detection device according to claim 2,
wherein the at least one processor is configured to execute the instructions to map the motion pattern and the relation belonging to the same class to the same lexical description through the classification.

4. The intention detection device according to claim 3,
wherein the at least one processor is configured to execute the instructions to gradually enhance a library through the unsupervised or semi-supervised learning, the library at least containing with respect to each class of the motion pattern and the relation:
a criterion for determining a class of the motion pattern and the relation;
and a lexical description of the class.

5. The intention detection device according to claim 1,
wherein the at least one processor is configured to execute the instructions to
generate a dynamic variation signal from the preprocessed data and
partition and normalize the preprocessed data by detecting characteristic time-instants based on the dynamic variation signal to identify the motion pattern.

6. The intention detection device according to claim 1,
wherein the at least one processor is configured to execute the instructions to identify a lexical description of the motion pattern and the relation, and
the at least one processor is configured to execute the instructions to convert the lexical description to data in a numerical format to detect the at least one of the activity, the gesture or the predicted step.

7. The intention detection device according to claim 6,
wherein the at least one processor is configured to execute the instructions to perform nonlinear dynamic processing and nonlinear static processing of the data in the numerical format to detect the at least one of the activity, the gesture or the predicted step.

8. The intention detection device according to claim 7,
the at least one processor is configured to execute the instructions to perform second nonlinear static processing of data derived from the nonlinear dynamic processing and the nonlinear static processing to detect the at least one of the activity, the gesture or the predicted step.

9. The intention detection device according to claim 8,
wherein the at least one processor is configured to execute the instructions to perform the second nonlinear static processing further based on a dynamic variation signal generated from the preprocessed data and timing information regarding the motion pattern.

10. The intention detection device according to claim 1,
wherein the at least one processor is configured to further execute the instructions to, if a lexical description of the motion pattern is unknown, search a motion pattern library for the lexical description and evaluate consistency of the lexical description over time.

11. An intention detection method comprising:
generating preprocessed data associated with a human and a relevant object by processing a detection signal outputted by a sensor;
identifying a motion pattern of the human and a relation(-ship) between the human and the object based on the preprocessed data; and
detecting at least one of an activity, a gesture or a predicted step regarding the human based on the identified motion pattern and the identified relation able to integrate and provide lexical descriptions of the at least one of the activity, the gesture or the predicted step.

12. A non-transitory computer-readable storage medium storing instructions that, when executed by a processor, cause the processor to:
generate preprocessed data associated with a human and a relevant object by processing a detection signal outputted by a sensor;
identify a motion pattern of the human and a relation(-ship) between the human and the object based on the preprocessed data; and
detect at least one of an activity, a gesture or a predicted step regarding the human based on the identified motion pattern and the identified relation able to integrate and provide lexical descriptions of the at least one of the activity, the gesture or the predicted step.
